(19) United States
(12) Patent Application Publication
(10) Pub. No.: US 2018/0126346 A1
(43) Pub. Date: May 10, 2018

(54) DISPENSING APPARATUS AND RELEASABLY CONNECTED FLUID CONTAINER FOR USE IN SUCH DISPENSING APPARATUS

(71) Applicant: Fast & Fluid Management B.V., Sassenheim (NL)

(72) Inventors: Johannes Hermanus Nicolaas Post, Sassenheim (NL); Mark Baak, Lisse (NL)

(73) Assignee: Fast & Fluid Management B.V., Sassenheim (NL)

(21) Appl. No.: 15/802,871

(22) Filed: Nov. 3, 2017

(30) Foreign Application Priority Data
Nov. 4, 2016 (EP) 16197376.3

(51) Int. Cl. B01F 13/10; B01F 7/00

(52) U.S. Cl. CPC B01F 13/1066; B01F 13/1058; B01F 2003/0028; B01F 13/1063; B01F 7/00216

(57) ABSTRACT

Apparatus for dispensing a plurality of fluids, comprising a plurality of fluid containers and a carrier on which a plurality of pumps is mounted. Each one of said plurality of fluid containers is releasably connectable to an associated pump of said plurality of pumps via a connector assembly thereby forming a fluid connection between the fluid container and the associated pump. The connector assembly comprising a first connector to the associated pump and a mating second connector to the respective fluid container and wherein at least one of said plurality of fluid containers comprises a refill opening for refilling the fluid container.

### RELATED DOCUMENTS

This application claims the benefit of priority to European patent application Serial No. 16197376.3 filed Nov. 4, 2016, and entitled “DISPENSING APPARATUS AND RELEASABLY CONNECTED FLUID CONTAINER FOR USE IN SUCH DISPENSING APPARATUS.” The entirety of the aforementioned application is incorporated herein by reference.

### BACKGROUND

The present disclosure relates to an apparatus for dispensing a plurality of fluids, comprising a plurality of fluid containers and a carrier on which a plurality of pumps is mounted. The invention also pertains to fluid containers for use in such dispensing apparatus.

A device of this kind is described in WO 2012/093020. The prior art device dispenses a plurality of fluids such as decorative paint colourants from a plurality of containers holding a fluid. The containers are fixedly connected to a pump and a valve, thereby forming a module which module is mountable on a support such as a turntable. The turntable controllably rotates to position a specific module to a dispense location, such that sequential dispensing from several modules result in a specific fluid mix, e.g. a specific colour of paint. When a container is empty, it is refillable by opening a top lid of the container.

It is further known from WO 2005/039747 to have a fluid dispensing apparatus comprising a rotatable turntable on which a plurality of valves and pumps are mounted which are releasably connected to a plurality of closed containers, i.e. non-refillable containers, which are releasably connectable to a pump and valve by means of a pair of mating connectors. Examples of such closed containers include bag-in-box type of containers. This type of dispensing apparatus is commonly applied for e.g. hair colourants. In this type of applications the fluid may be unsuitable for contact with ambient air for various reasons.

In some areas of application of these types of dispensing devices, users are accustomed to using refillable containers. Therefore the devices sold and used in those areas of application, such as decorative paint dispensing devices, comprise turntables with open, refillable containers.

However, increasingly stricter regulations urge manufacturers of these dispensed fluids to reduce the amount and restrict types of allowed anti-bacterial and/or anti-fungal additives.

Bacteria and fungus growth are therefore less inhibited and thus the influence of these micro-organisms on the quality of these dispensed fluids increases.

### SUMMARY

In a first aspect of the present invention, a dispensing apparatus for dispensing a plurality of fluids is provided, comprising a plurality of fluid containers and a carrier on which a plurality of pumps is mounted, each one of said plurality of pumps is connected to a valve, and wherein each one of said plurality of fluid containers is releasably connectable to said plurality of pumps via a connector assembly thereby forming a fluid connection between the fluid container and the respective pump, the connector assembly comprising a first connector to the respective pump and a mating second connector to the respective fluid container and wherein at least one of said plurality of fluid containers comprises a refill opening for refilling the fluid container.

By providing a dispensing apparatus having a fluid container having a refill opening for refilling the fluid container, and having the fluid container releasably connectable to one of the plurality of pumps, users who are presently accustomed to using refillable fluid containers are able to invest in an apparatus in line with their present practice, while being able to switch to closed, non-refillable fluid containers later on during the life-cycle of the dispensing apparatus, e.g. in case a single one or all of the dispensed fluids require a closed container, for example because of increasingly strict environmental and/or health regulations.

It is therefore further advantageous that the fluid containers holding the consumable fluid of the dispensing apparatus, are releasably connectable to a pump and a valve of the dispensing apparatus. A fluid container in itself may also be considered a consumable, as the fluid containers may be e.g. disposable or refillable. Consequently, while replacing the consumable of the dispensing apparatus, the pump and valve are not necessarily replaced at the same time.

The dispensing apparatus is formed and configured for dispensing of a plurality of fluids from a fluid container. This plurality of fluids may be a single type of fluid or a fluid from a wide range of fluid-types. Commonly, the plurality of fluids varies in one or more characterizing parameters of the fluid, such as viscosity, colour, temperature and the like. Within the framework of the invention, the term “fluid” as used herein, is defined as any flowable material that can be dispensed by the apparatus according to the present invention. Examples of fluids include liquids, pastes, granulates, and powders.

The dispensing apparatus comprises a carrier on which a plurality of pumps is mounted. The carrier may be provided as a single element or module, or be distributed over several elements, such as e.g. multiple discs on top of each other in a multistore configuration. The carrier may be a stationary carrier type, such as e.g. a fixed platform or frame construction or be controllably moveable in any suitable way, such as e.g. rotational or linear by means of any suitable drive means such as for example an electrical rotational drive motor, stepper motor, belt drive or electro-magnetic linear drive motor. The drive means being controlled by a suitable drive control unit, which may be integral part of the drive means, at a remote site or distributed over the apparatus. The plurality of pumps is mounted on the carrier. This may be implemented as a substantially permanent mounting, e.g. by means of riveting, welding, gluing or otherwise attaching, by means of a durable connection, such as e.g. screwing, bolting and the like of by means of a manually detachable and re-attachable connection, such as a snap connection.

Each one of said plurality of pumps is connected to a valve via a fluid connection. The valve may be integrally formed with the pump itself or e.g. formed as a separate unit. The pump and valve may be connected directly to each other or alternatively via a fluid duct or tubing.

The plurality of fluid containers is releasably connectable to an associated pump of said plurality of pumps. Within the context of this invention, this comprises both the state in which the fluid container is connected to a pump of the plurality of pump and also the state in which a fluid container is separated from the pump, but able to be connected thereto. Within the context of this application, the term “connectable” defines a state in which the associated object is physically connected, or is able to be connected. This connecting and disconnecting may be performed manually by a user or assisted by a specific adapted release and/or installation tool, such as e.g. a manual tool or an automated connect and disconnect means.

The fluid container is connectable to the associated pump and valve via a releasably connectable connection of the connector assembly. A first connector of the connector assembly is connected to the pump. The connector may be formed as an integral portion of the pump or as a separate element. The fluid container comprises a mating second connector. The second connector may be formed as an integral part of the fluid container or as a separate element in fluid connection with the container. The first and second connector may be a male and female connector or vice versa, or any other connector combination to form a fluid connection between the two parts. It may be advantageous to provide a male type connector at the pump side and a female type connector at the container side for reasons of complexity and transport efficiency of the consumables.

The fluid container comprises a refill opening for refilling the container. The refill opening is located at a suitable location on the container, as to enable a refilling of said container. Although the term “opening” is used, the refill opening may include a closure means or lid of any kind. The refill opening should enable a user to repeatedly refill the container by adding a volume of fluid to the container without significantly damaging the fluid container. Refilling the container may be performed manually or by applying a specific refill tool. It may be advantageous to provide a refill opening in a top portion of the container and/or to provide a closing means such as a pivotable or slidable hatch or a (screw) cap to open and/or close the refill opening accordingly.

The dispensing apparatus may further comprise a central dispensing position, which may comprise a holder for a receptacle such as e.g. a bucket or an open canister for receiving dispensed quantities from the various fluid containers. In operation, an open canister is placed on the holder of the central dispensing position and depending on the required mix or recipe one or more valves are moved over the receptacle by the controllably moveable carrier to enable the sequentially or parallel dispensing of a specific volume of fluid from the fluid container by actuating the associated pump. Depending on the actual recipe or desired mix of fluids, the controllably moveable carrier moves the next required fluid valve over the central dispending position after which the pump is actuated again to dispense another quantity of fluid from the associated container. In case of a stationary carrier, the open canister at the (central) dispensing position may be provided with the desired quantity of fluids by means of e.g. suitable tubing or ducts from the fluid containers to the dispensing position.

In an embodiment of the dispensing apparatus according to the invention, it comprises a housing at least partly enclosing the plurality of fluid containers and the plurality of pumps, the housing comprising a maintenance gate, e.g. in a top or front portion of the housing, the maintenance gate is formed such that at least one of said plurality of fluid containers is manually removable through the maintenance gate. This maintenance gate may be a permanent opening or may comprise e.g. a closable hatch. It may be advantageous e.g. for safety reasons to provide an electronically controlled locking mechanism at the maintenance gate, to restrict access to the fluid containers. In an embodiment of the dispensing apparatus according to the invention, the controllably moveable carrier comprises a rotatable turntable. A rotatable configuration contributes to a compact footprint of the apparatus as a whole and reduces complexity in the drive mechanism of the carrier on which the pumps and valves are mounted.

In an embodiment of the dispensing apparatus according to the invention, the apparatus comprises a retainer assembly for releasably engaging and disengaging with an engaging means of the fluid container. Having such a retainer assembly increases the overall operating reliability and decreases the risk of undesired disconnecting the fluid connection between the fluid container and the pump and valve, which may otherwise result in leakages. The retainer assembly may be of any suitable construction, such as a clamping mechanism, a bimodal element or a screwing type mechanism. The retainer assembly engages with engaging means on the fluid container, which may be any suitably formed surface or element to assist in holding down the fluid container and/or protecting the fluid connection.

In a further embodiment of the dispensing apparatus, the retainer assembly comprises a lever mounted on a pivot axis, which lever comprises an operating handle on a first side of the pivot axis and an arm for operatively engaging with the connector assembly on a second remote side of the pivot axis with respect to the first side. By moving the handle on the proximal end e.g. upward or downward, depending on the specific configuration, the arm on the distal end pivots and by operatively engaging with the connector assembly thereby disconnecting the first and second connectors of the connector assembly while pushing the fluid container out of its engaged position and assisting a user to remove such fluid container more easily. The other way around, pressing the handling into an engaging position may assist a user to connect a fluid container onto the carrier and/or onto the connector of the pump and valve assembly.

In an embodiment of the dispensing apparatus according to the invention, the mating second connector to the fluid container is a connector of the non-spill connector type, configured such that the fluid is not spilled during a disconnection of the connector assembly, even if the fluid connector is still (partially) filled with fluid. Non-spill connectors are in itself known in the art. It may be appreciated that this type of connectors enable an operator to remove a container from the dispensing apparatus, even when it is not completely empty, e.g. to temporarily replace a specific colourant with another colourant.

In an embodiment of the dispensing apparatus according to the invention, the dispensing apparatus further comprises means for detecting whether a fluid container is correctly connected. These detection means recognize whether a container is positioned and connected to avoid dispensing from a not completely (correct) connected container or dispensing from a container installed in the wrong slot. The detection means may be based on electrical contact, electric field material detection, vision system, or any other suitable detection means.

In an embodiment of the dispensing apparatus according to the invention, the retainer assembly and the fluid containers are configured such that in a first, engaging position of the retainer assembly, the fluid container is connected to the associated pump while a portion of the retainer assembly abutting the fluid container, thereby biasing the fluid container onto the carrier.

Advantageously the handle may be used both as a user handle as well as a retainer portion towards the fluid container, in particularly, the handle may advantageously follow the shape of the abutting portion of the fluid container. This construction provides a simple and compact solution to retain a fluid container and its fluid connection with the associated pump and valve.

In an embodiment of the dispensing apparatus according to the invention, the apparatus comprises a closing means for operatively engaging with the refill opening to close and open the refill opening. The closing means may include any suitable closing means such as e.g. a controllably driven shutter, a spring loaded closing hatch or a screw cap or lid. Some applications and/or fluids require additional sealing, for example to prohibit curing of the fluid in the container. Therefore additional sealing means may be applied at the refill opening and/or the closing means.

In an embodiment of the dispensing apparatus according to the invention, the dispensing apparatus is a paint dispenser and the plurality of fluid containers comprise colourants, such as decorative paint. Using the dispenser by applying a variety of colourants in the fluid container, dispensing a specific recipe or mix of colourants may result in a specific colour of the paint in the receptacle at the central dispensing position. It may be particularly advantageous to provide the basic colourless paint, latex and or lacquer in an open canister, while providing suitable colourants in the plurality of fluid containers. By means of a lookup table in a controller, any desired colour within the gamut of the provided base colourants may be accomplished by dispensing a predetermined amount of the plurality of colourants to the central dispensing position. A shaking of mixing operation may be subsequently required to homogenise the plurality of colourants into the base paint.

In an embodiment of the dispensing apparatus according to the invention, the apparatus comprises a controller comprising a processor and an electronic memory, for controlling at least one parameter indicative for an amount of fluid dispensed from at least one of said plurality of fluid containers. By providing such electronic means, a user is assisted in mixing the several fluids and/or several states of the fluids in a desired fashion to render the desired output parameters of the resulting mixture. Parameters may include e.g. viscosity, colour, temperature and the like. It may be further advantageous to provide a lookup table, calculation model or similar means, to calculate the required mix of fluids to render the desired output.

In an embodiment of the dispensing apparatus according to the invention, the dispensing apparatus comprises a user-machine interface unit, wherein the user-machine interface comprises at least one user input for controlling a maintenance operation or a dispensing operation. Such input may comprise e.g. a specific mix requirement and/or an input indicating that a refill or replacement of one of the plurality of fluid containers is desired. The latter may result in moving that specific fluid container to a position accessible through the maintenance gate of the housing, such that the user may perform the refill or replacement operation.

In an embodiment of the dispensing apparatus according to the invention, the controllably moveable carrier is controlled in accordance with the user input wherein the user input indicates a selected fluid container, such that the selected fluid container is positioned adjacent the maintenance gate for replacement or refilling thereof. By this cooperation between user interface and positioning of the fluid container(s) in need of maintenance, the user is heavily assisted in performing maintenance activities such as refilling, replacing and the like.

In an embodiment of the dispensing apparatus according to the invention, the apparatus further comprises a guide for guiding and aligning the plurality of fluid containers during an installation operating of such fluid container in the dispensing apparatus. These guide members may be constructional guide means such as sheet metal frame elements, plastic guides, rotating guide wheels and the like. These guide means increase the likeliness of a user inserting a new or additional fluid container in the correct position and orientation for the fluid connection to complete.

In an embodiment of the dispensing apparatus according to the invention, the apparatus further comprises detecting means for detecting at least one property of a connected or connectable fluid container, such as e.g. a contained volume, color information, viscosity, or the like. The detecting means may e.g. comprise means to read a barcode or QR code, a RFID tag reader, a vision system or e.g. digital information exchange.

In a second aspect of the present invention, a releasably connectable fluid container for use in the dispensing apparatus according to the first aspect of the present invention is provided, comprising a connector for connecting to the mating connector of the dispensing apparatus, and further comprising a refill opening for refilling the releasably connectable fluid container. Such a refillable and interchangeable container which is releasably connectable to a dispensing apparatus as described hereabove, enables a user to both use a refillable apparatus in a fashion that the user is used to, while the dispensing apparatus is also suitable for use with closed, non-refillable containers, such as e.g. a bag-in-box container.

In an embodiment of the releasably connectable fluid container for use in the dispensing apparatus according to the first aspect of the present invention, the fluid container is adapted to be manually inserted in and manually removed from the dispensing apparatus through the maintenance gate of the housing of the dispensing apparatus. The fluid container may be of any suitable form and material. Adapting the fluid container to the configuration of the maintenance gate and/or vice versa contributes to easier performance of maintenance tasks for a user, in particular operations regarding to refilling and/or replacement of a fluid container.

In an embodiment of the releasably connectable fluid container for use in the dispensing apparatus according to the first aspect of the present invention, the fluid container comprises engaging means for releasably engaging and disengaging with the retainer assembly of the dispensing apparatus. To guide the retainer means of the dispensing apparatus on the fluid container, or even contributing to the functioning thereof, the fluid container may comprise engaging means. These engaging means may be of any suitable type, and may comprise e.g. an abutment surface, a ridge, magnetic means that attract the retainer assembly, or the like.

In another aspect of the present invention, a method of replacing a selected fluid container in a dispensing apparatus is provided, wherein the selected fluid container comprises a refill opening for refilling the selected fluid container, and the method comprising the steps of disconnecting a fluid connection between the selected fluid container and an associated connected pump (35) of the dispensing apparatus, releasing the selected fluid container from the associated pump by disconnecting a mating connector assembly (29, 32) between the selected fluid container and the associated pump (35), and introducing a replacement container under the formation of a fluid connection between the replacement container and the associated pump. The selected fluid container is released or disconnected from the connector assembly to be replaced by a replacement container. This replacement container may comprise a refill opening for refilling the replacement container or may be a closed container, i.e. a container without a refill opening. Note that such a closed container may comprise an outlet by means of e.g. the (mating) connector. Suitable closed containers may be of the bag-in-box-type of container or any other type of fluid container without a refill opening.

### BRIEF DESCRIPTION OF THE DRAWINGS

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description and the accompanying schematical drawings which are not limitative of the present invention, and wherein:

FIG. 1 is a schematic perspective view of a dispensing apparatus for dispensing a plurality of fluids according to the present invention in conjunction with an external computer system;

FIG. 2A is a schematic perspective view of a dispensing apparatus with a housing in a closed state according to the present invention;

FIG. 2B is a schematic perspective view of a dispensing apparatus with a housing in an opened state according to the present invention;

FIG. 3 is a schematic perspective detail of a turntable and guide system of a dispensing apparatus according to the present invention;

FIG. 4A is a schematic cross-section of a turntable with a disengaged fluid container of a dispensing apparatus according to the present invention;

FIG. 4B is a schematic cross-section of a turntable with an engaged fluid container of a dispensing apparatus according to the present invention; and

FIG. 5 is a schematic cross-section of a refillable fluid container according to the present invention.

### DETAILED DESCRIPTION

The present invention will now be described with reference to the accompanying drawings, wherein the same reference numerals have been used to identify the same or similar elements throughout the several views.

It is noted that the drawings are schematic, not necessarily to scale and that details that are not required for understanding the present invention may have been omitted. The terms “upward”, “downward”, “below”, “above”, and the like relate to the embodiments as oriented in the drawings, unless otherwise specified. Further, elements that are at least substantially identical or that perform an at least substantially identical function are denoted by the same numeral, where helpful individualised with apostrophe suffixes.

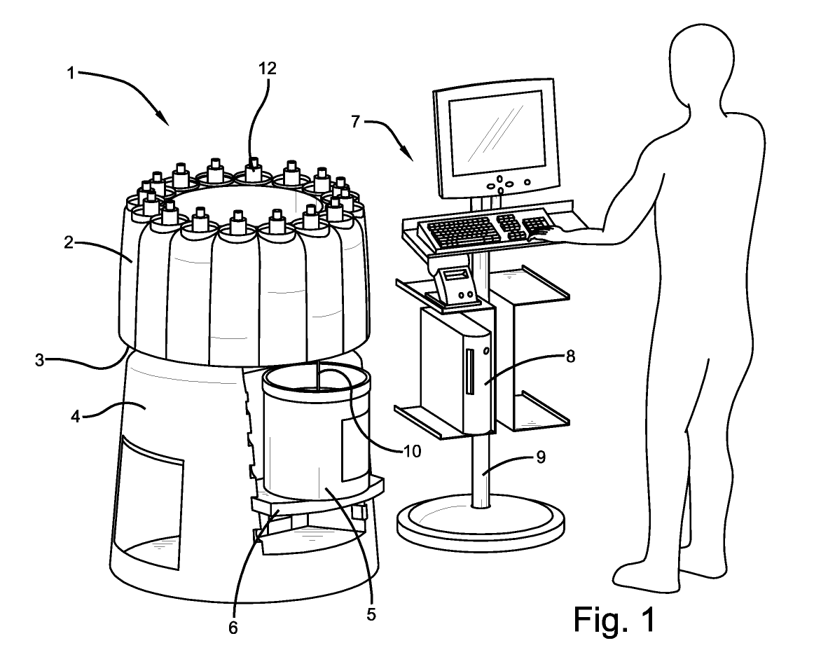

FIG. 1 schematically illustrates an example of a dispensing apparatus 1 for dispensing a plurality of fluids, such as (components of) paints, paint colourants, hair dyes, shampoos, foundations and the like. The apparatus can be used for dispensing numerous recipes and formulas of the said products and can be located e.g. at a retailer of decorative paints, a hairdresser, a warehouse, or a factory. This particular dispensing apparatus 1 is an automated version and includes a horizontal turntable 3, with a plurality of fluid containers 2 mounted along its circumference. Optionally the apparatus may comprise an enclosing housing around the plurality of fluid containers. The fluid containers 2 in this example comprise a refill opening which is closable and re-openable by means of a (screw) cap 12. Each fluid container 2 is releasably connected with a pump 35 and a dispense valve 39 via a connector assembly. The turntable 3 can be rotated between discrete positions, e.g. twelve or sixteen positions including a central dispensing position where the dispensed fluid 10 is dispensed in a receptacle, in this example a bucket 5 on an adjustable shelf 6. The apparatus 1 includes a base 4 made e.g. by injection moulding a polymer. A computer 8 for entering and storing information, such as customer data and recipes, and generating instructions for driving the turntable, pumps and valves, is positioned on a separate stand 9, also supporting a user interface 7 for rendering information to the user and providing input means. Further information regarding suitable turntables and procedures for driving the various components, are disclosed in, for instance, European patent applications EP 800 858, EP 1 492 970, EP 1 688 652, and EP 2 198 950.

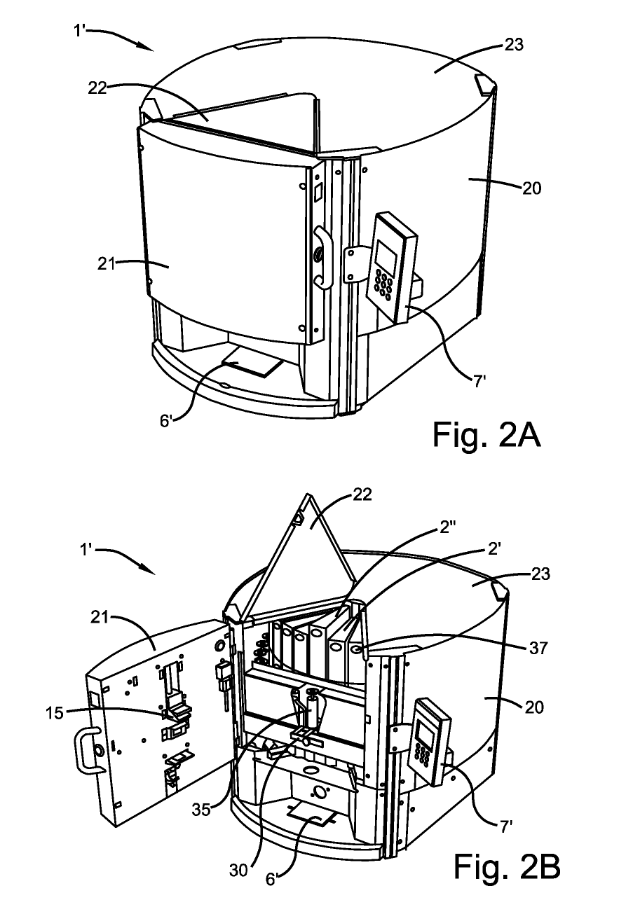

FIG. 2A schematically illustrates another example of a dispensing apparatus 1′ for dispensing a plurality of fluids with a housing in a closed state. Normally during operation of the dispensing apparatus 1′, the access door 21 and the maintenance gate 22 are closed. The dispensing apparatus 1′ has an enclosing housing 20 and a top cover 23. The maintenance gate 22 is formed as a hatch in the top cover 23. A user interface unit 7′ has been mounted on the housing 20. The dispensing apparatus 1′ comprises a shelf 6′ on which a receptacle can be placed to receive the sequentially dispensed fluids at the central dispensing position.

FIG. 2B shows the dispensing apparatus 1′ of FIG. 2A wherein the door 21 and the maintenance gate 22 are opened. The plurality of fluid containers 2′ is visible through the opening of the door 21 and maintenance gate 22, including one fluid container 2″ which is elevated with respect to the other fluid containers 2′. The elevation indicates that the handle 30 of the retainer means has been pivoted into the disengaged downward position. The door 21 comprises a pump actuator 15 which interacts with the top of associated pump of the plurality of pumps 35. The head of the pump 35 at the central dispensing position will be positioned in between two flaps of the pump actuator 15 during a rotation of the turntable 3. If, in operation, the fluid container is placed in the connected state an upward and downward movement of the pump actuator 15 results in an upward and downward movement of the pump 35, which is, in contrast to the depicted state of the fluid container 2′ during normal operation, in fluid connection with the fluid container 2′, thereby pumping a volume of fluid from the fluid container 2′ into or towards the pump 35 such that by opening a valve (not shown) a volume of fluid 10 is dispensed into a receptacle located at the shelf 6′. The releasably connectable fluid container 2′, 2″ is refillable through a refill opening 37, which is in this embodiment closable and openable by means of an associated (screw) cap.

The elevated fluid container 2″ is in a disengaged position in which the fluid connection between the fluid container and the pump and valve is interrupted. By means of an arm (not shown in FIG. 2B) on a distal end of the handle 30, the fluid container 2″ has been elevated. This assists the user to remove the fluid container 2″ through the hatch of the maintenance gate 22 while the pump 35 and associated valve remain mounted on the turntable 3.

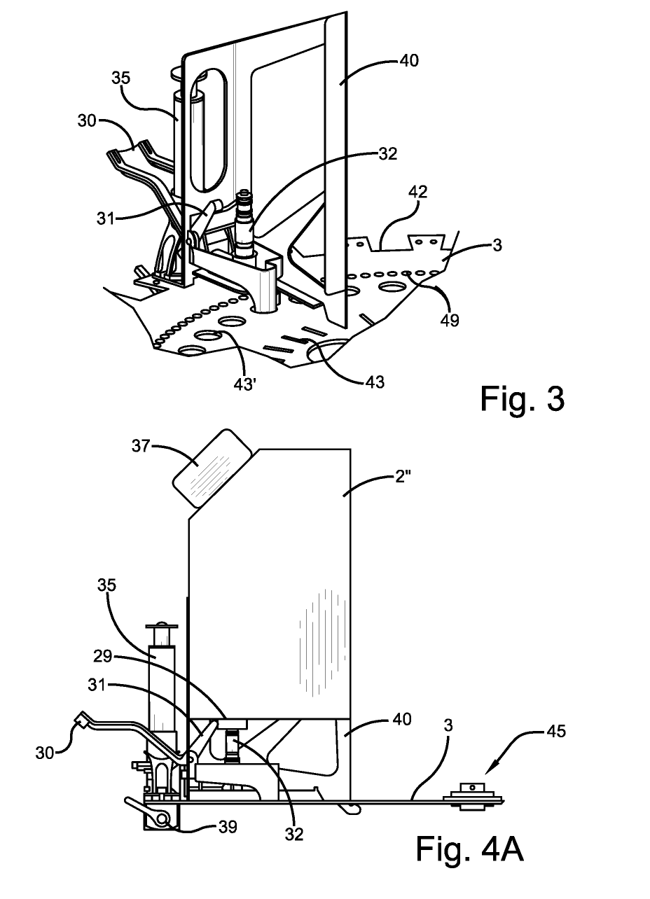

FIG. 3 shows a perspective detail of the turntable and guide system of the dispensing apparatus. Turntable 3 comprises several openings, protrusions, holes and slits, such as positioning holes 49, which are used to measure the movement of the turntable by means of a light and photocell (not shown), and slits 43, 43′ in which guide frame 40 and the connector 32, pump 35 and retainer assembly 30, 31 are mounted and fastened by means of a snap connection. To accommodate the pump 35, valve and retainer assembly 30 a plurality of slots 42 are provided around the circumference of the turntable 3.

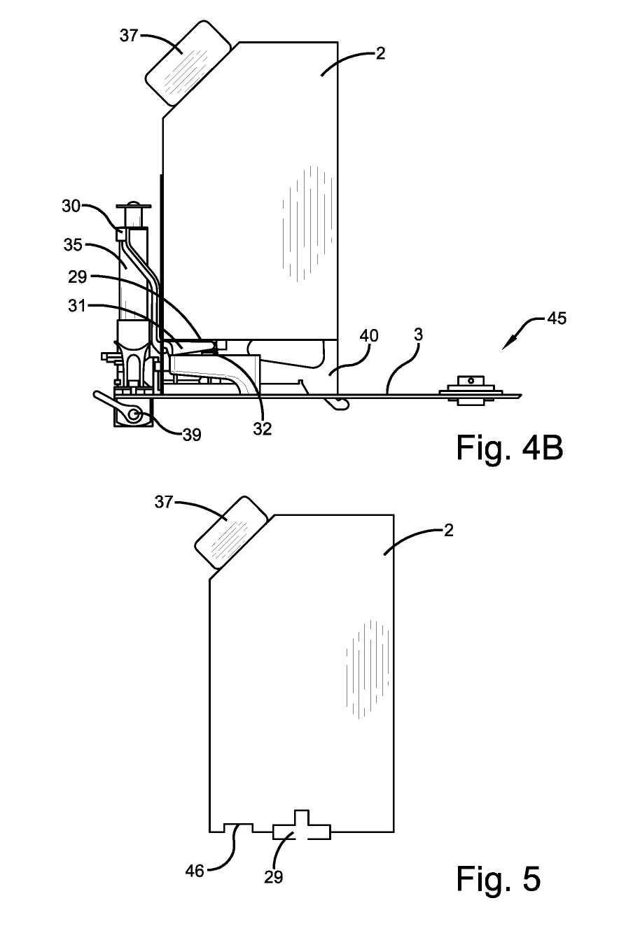

FIG. 4A shows a schematic cross-sectional view of the turntable 3 and guide system of FIG. 3 wherein a fluid container 2″ has been inserted in registration with the guide means 40. The screw cap 37 has been screwed on the refill opening of the fluid container after a refill operation. The turn table is driven by an electric rotational drive motor 45. The male connector portion 32 which is mounted on the turntable 3 has been mated with the female connector portion 29 of the fluid container 2″. In the currently depicted state the fluid connection between the fluid container 2″ and the pump 35 has not yet been completed. The fluid container 2″ rests on the arm portion 31 of the retainer assembly 30. To complete the fluid connection via the connector assembly 32, 29 the handle of the retainer assembly 30 is moved upward towards the housing of the pump 35, thereby pivoting the arm 31 downward and urging the female connector 29 of the fluid container 2″ over the male connector 32 opening the fluid connection between the fluid container 2″ and the pump 35 and valve 39 as depicted in FIG. 4B.

FIG. 5 shows schematic cross-section of a refillable fluid container 2. The fluid container 2 comprises a refill opening in a top portion of the injection moulded fluid container 2. An associated screw cap 37 is applied to enable manually closing and opening thereof. Engaging means 46 comprise a surface which in operation engages with the arm portion 31 of the retainer means of the dispensing apparatus to aid in connecting and/or disconnecting the fluid container 2 with respect to the dispending apparatus 1. The fluid container 2 further comprises a female connector portion 29 configured to form a mating engagement with the male connector portion 32 of the dispensing apparatus while further sealing the fluid container 2 in disengaged state, to prevent leaking of the fluid from within the fluid container 2.

Further, the terms and phrases used herein are not intended to be limiting; but rather, to provide an understandable description of the invention. The terms “a” or “an”, as used herein, are defined as one or more than one. The term “plurality”, as used herein, is defined as two or more than two. A plurality may also indicate a subset of two or more, out of a larger multitude of items. The term “another”, as used herein, is defined as at least a second or more. The terms including and/or having, as used herein, are defined as comprising (i.e., open language). The term “coupled”, as used herein, is defined as connected, although not necessarily directly. The term “fluid” as used herein, is defined as any flowable material that can be dispensed by the apparatus according to the present invention. Examples of fluids include liquids, pastes, granulates, and powders.

Elements and aspects discussed for or in relation with a particular embodiment may be suitably combined with elements and aspects of other embodiments, unless explicitly stated otherwise. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. Apparatus for dispensing a plurality of fluids, comprising a plurality of fluid containers (2) and a carrier (3) on which a plurality of pumps (35) is mounted, and wherein each one of said plurality of fluid containers (2) is releasably connectable to an associated pump (35) of said plurality of pumps via a connector assembly thereby forming a fluid connection between the fluid container (2) and the associated pump (35), the connector assembly (29, 32) comprising a first connector (32) to the associated pump (35) and a mating second connector (29) to the respective fluid container (2) and wherein at least one of said plurality of fluid containers (2) comprises a refill opening for refilling the fluid container.

2. Dispensing apparatus according to claim 1, wherein the carrier (3) is controllably moveable.

3. Dispensing apparatus according to claim 2, wherein the controllably moveable carrier comprises a rotatable turntable (3).

4. Dispensing apparatus according to claim 1, further comprising a retainer assembly (30) for releasably engaging and disengaging with an engaging means (46) of the fluid container (2).

5. Dispensing apparatus according to claim 4, wherein the retainer assembly (30) comprises a lever mounted on a pivot axis, which lever comprises an operating handle (30) on a first side of the pivot axis and an arm (31) for operatively engaging with the connector assembly on a second remote side of the pivot axis with respect to the first side.

6. Dispensing apparatus according to claim 1, further comprising a closing means (37) for operatively engaging with the refill opening to close and open the refill opening.

7. Dispensing apparatus according to claim 1, wherein the dispensing apparatus is a paint dispenser and the plurality of fluid containers comprise colourants, such as colourants for decorative paint.

8. Dispensing apparatus according to claim 1, further comprising a controller comprising a processor and an electronic memory, for controlling at least one parameter indicative for an amount of fluid dispensed from at least one of said plurality of fluid containers (2).

9. Dispensing apparatus according to claim 1, comprising a user-machine interface (7, 7′), wherein the user-machine interface (7, 7′) comprises at least one user input for controlling at least a maintenance operation or a dispensing operation.

10. Dispensing apparatus according to claim 1, further comprising a guide (40) for guiding and aligning the plurality of fluid containers (2) during an installation operating of such fluid container (2) in the dispensing apparatus (1).

11. Dispensing apparatus according to claim 1, further comprising a housing (20, 23) at least partly enclosing the plurality of fluid containers (2) and the plurality of pumps (35), the housing comprising a maintenance gate (22), the maintenance gate (22) is formed such that at least one of said plurality of fluid containers is manually removable through the maintenance gate (22).

12. Releasably connectable fluid container for use in the dispensing apparatus according to claim 1, comprising a connector (29) for connecting to the mating connector (32) of the dispensing apparatus (1), and further comprising a refill opening for refilling the releasably connectable fluid container.

13. Releasably connectable fluid container, according to claim 12, wherein the fluid container is adapted to be manually inserted in and manually removed from the dispensing apparatus (1) through the maintenance gate (22) of the housing (20, 23) of the dispensing apparatus.

14. Releasably connectable fluid container, according to claim 12, comprising engaging means (46) for releasably engaging and disengaging with the retainer assembly (3) of the dispensing apparatus (1).

15. Method of replacing a selected fluid container in a dispensing apparatus, the selected fluid container comprising a refill opening for refilling the selected fluid container, and the method comprising the steps of
disconnecting a fluid connection between the selected fluid container and an associated connected pump (35) of the dispensing apparatus;
releasing the selected fluid container from the associated pump by disconnecting a mating connector assembly (29, 32) between the selected fluid container and the associated pump (35);
introducing a replacement container under the formation of a fluid connection between the replacement container and the associated pump.
